(19) United States
(12) Patent Application Publication
(10) Pub. No.: US 2003/0121746 A1
(43) Pub. Date: Jul. 3, 2003

(54) Locking clutch

(75) Inventor: Xiaolan Ai, Massillon, OH (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: The Timkin Company

(21) Appl. No.: 10/034,653

(22) Filed: Dec. 27, 2001

(51) Int. Cl. F16D 11/14

(52) U.S. Cl. 192/69.61; 192/69.6; 192/69.7

(57) ABSTRACT

A locking clutch of the present invention comprises a toothed member which is connectable to a drive part and a slide assembly which is connectable to a driven part. The toothed member comprises a cylindrical surface and a plurality of teeth spaced about and extending from said cylindrical surface. The slide assembly comprises a base and a wall extending from an end surface of the base. The wall is narrower than the base, and the base and wall define a shoulder where they intersect. A plurality of pockets are formed in the shoulder and extend axially into the base from the shoulder. A plurality of grooves are formed in the wall above the pockets, there being one groove for each pocket. A slide member (such as a roller) and a resilient member (such as a coiled spring) are received in each pocket. The slide member is slidable axially in the pocket, and the spring member urges said slide member toward the mouth of the pocket. A stop, preferably in the form of a snap ring, extends around the slide assembly wall above the slide members. The snap ring is positioned to prevent the slide members from fully exiting the pockets to maintain the slide members in the slide assembly.

### CROSS-REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

This invention relates to clutches, and, in particular, to a locking clutch that connects two or more mechanical components together for torque and/or power transmission.

Various clutching devices are used to selectively connect mechanical components together so that they can rotate at the same angular speed about a common axis, allowing torque and power to be transmitted from one component to the other. There are two common types of clutches: (1) progressive engagement clutches, such as friction clutches; and (2) positive engagement clutches, such as dog clutches. A friction clutch assembly usually contains two sets of friction plates mounted respectively to driving and driven parts. It relies on friction force to transmit torque and power. The friction clutch provides high performance at differential speed engagement. Frictional clutches are widely used in automotive transmissions. The construction of a friction clutch, however, is very complex, involving frictional materials and usually requiring hydraulic systems to provide and maintain adequate normal forces. Consequently, the costs associated with design and manufacture of friction clutches are high. In addition, the power losses of running the hydraulic system associated with friction clutches are high.

Dog clutches are much simpler in construction. A dog clutch typically includes a pair of jaws directed towards each other for engaging or disengaging the driving and driven parts. Dog clutches are used in hydro-mechanical transmissions and other continuously variable transmissions. They are also used in four-wheel drive vehicles for engaging the secondary driving wheels. However, the engagement is not always trouble free. There are times when the jaws of one member are not aligned up well with the grooves on the mating member. In this instance, the jaws will not engage into the grooves no matter what force is used to push the two members together.

### BRIEF SUMMARY OF THE INVENTION

Briefly stated, a locking clutch of the present invention comprises a toothed member which is connectable to a drive part and a slide assembly which is connectable to a driven part. The tooth member and the slide assembly can be brought into and out of engagement to transfer (or stop the transfer) of power and/or torque from the drive part to the driven part.

The toothed member comprises a cylindrical surface and a plurality of teeth spaced about and extending from the cylindrical surface.

The slide assembly comprises a base and a wall extending from an end surface of said base. The wall is narrower than the base, and the base and wall define a shoulder where they intersect. A plurality of pockets are formed in the shoulder and extend axially into the base from the shoulder. A plurality of grooves are formed in the wall above the pockets, there being one groove for each pocket. Thus, the groove is, in effect, a continuation of the pocket. A slide member (such as a roller) and a resilient member (such as a coiled spring) is received in each pocket. The slide member is slidable axially in the pocket, and the spring member urges the slide member toward the mouth of the pocket. A stop, preferably in the form of a snap ring, extends around the slide assembly wall above the slide members. The snap ring is positioned to prevent the slide members from fully exiting the pockets to maintain the slide members in the slide assembly pockets.

The teeth of the toothed member are spaced apart to define a gap between the teeth. The gap has a width, at the radial ends of the teeth, at least as large as the width of the slide members. When the toothed member and the slide assembly are urged into engagement, at least one of the slide members is received in a tooth gap of the toothed member, thereby positionally fixing the toothed member and the slide assembly relative to each other, to enable the transfer of power and/or torque from the drive part to the driven part. The remaining slide members are urged at least partially into their respective pockets by the axial ends of the teeth.

The number of teeth in the toothed member is not equal to (and is preferably smaller than) the number of slide members in the slide assembly. Preferably, the number of teeth is evenly divisible by the difference between the number of slide members and the number of teeth. The gap or space between adjacent teeth has a width, at the ends of the teeth, greater than the width of the slide members. Additionally, the side surfaces of the teeth have a shape which corresponds generally to the shape of the slide members.

In one preferred embodiment, the teeth are formed on an exterior surface of the toothed member. In this instance, the slide assembly base and wall share a common outer surface. The slide assembly base and wall define a ring, and the shoulder extends radially inwardly from the inner surface of the ring. Hence, the pockets, grooves, and slide members are all positioned along an inner surface of the slide assembly ring.

In a second embodiment, the toothed member is annular in shape and has an inner surface from which the teeth extend. In this embodiment, the toothed surface is the inner surface of the toothed member. The slide assembly base and wall, in this instance, share a common inner surface (or are cylindrical in shape); the grooves are formed on an exterior surface of the slide assembly wall; and the shoulder extends radially outwardly from the wall. Hence, the pockets, grooves, and slide members are all positioned along an outer surface of the slide assembly.

In a third embodiment, the toothed member is in the shape of a ring and has both an inner surface and an outer surface, with teeth extending from both the inner and outer surfaces. The clutch includes an outer slide assembly which is engageable with the outer teeth and an inner slide assembly which is engageable with the inner teeth. The outer slide assembly is identical to the slide assembly described above in the first embodiment, and the inner slide assembly is identical to the slide assembly described above in the second embodiment. In this third embodiment, a single drive part can drive two driven parts, either individually or simultaneously.

### BRIEF DESCRIPTION OF THE SEVERAL VIEWS OF THE DRAWINGS

FIG. 1 is an exploded view of a first illustrative embodiment of a locking clutch of the present invention showing a toothed member and slide assembly of the locking clutch;

FIG. 2 is an exploded view of the slide assembly;

FIG. 3 is a cross-sectional view of the slide assembly taken along line 3-3 of FIG. 1

FIG. 4 show the fit between adjacent slide members of the slide assembly with teeth of the toothed member;

FIGS. 5-7 depict different angular alignments about a common axis between the toothed member and the slide assembly; and

FIG. 8 is an exploded view of a second illustrative embodiment of the locking clutch; and

FIG. 9 is an exploded view of an alternative embodiment of the locking clutch of FIG. 1.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention.

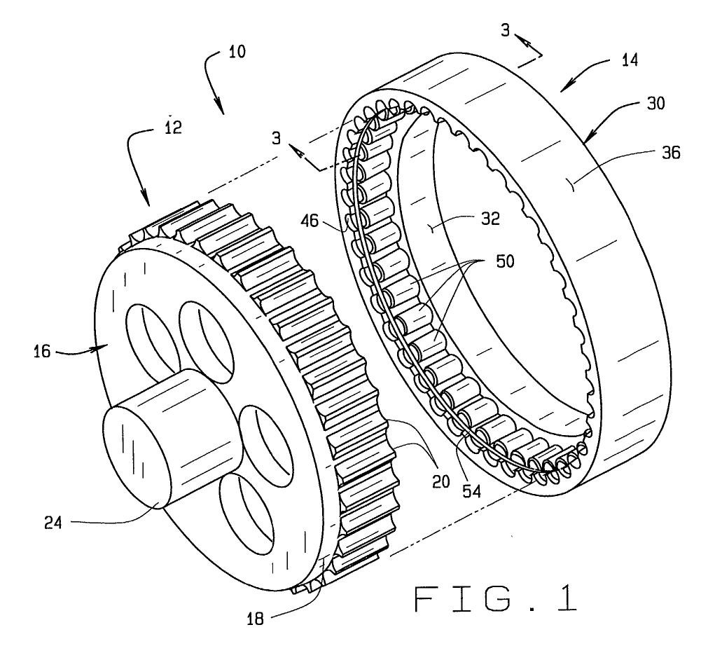

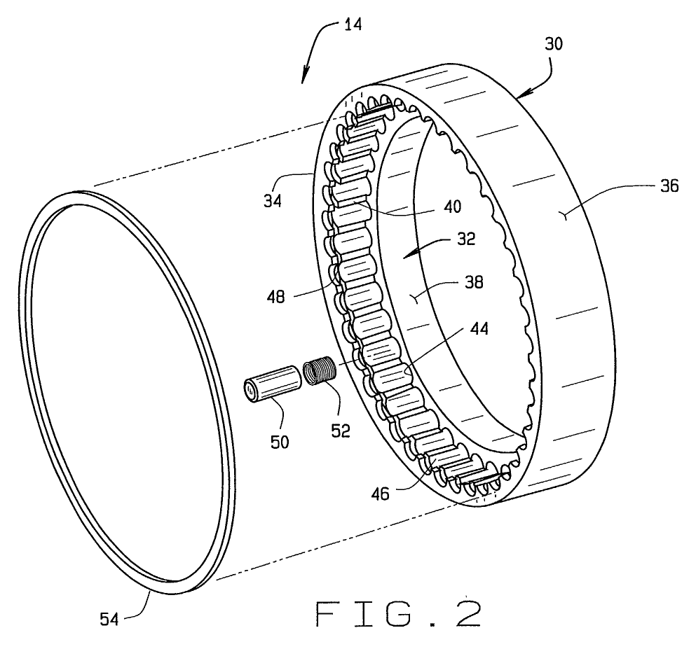

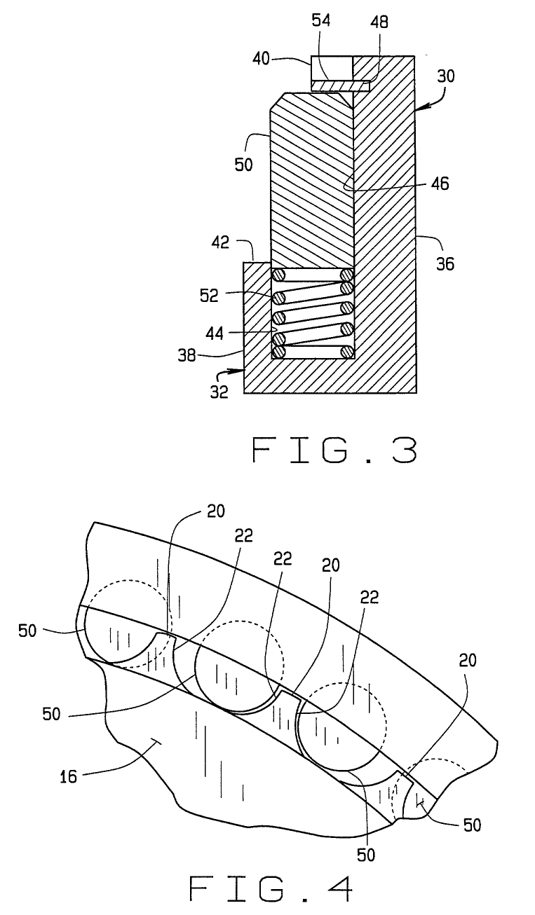

A locking clutch 10 of the present invention is shown generally in FIGS. 1 and 2. The locking clutch includes a toothed member 12 and a slide assembly 14 to which a drive and driven parts are operatively connected. As will be discussed below, the toothed member 12 and slide assembly 14 can be engaged to transmit torque and power from a drive part to a driven part, and disengaged to stop the transmission of power and torque from the drive part to the driven part. When assembled to the drive and driven parts, the toothed member 12 is preferably connected to the drive part and the slide assembly is preferably connected to the driven part. However, the toothed member 12 can be connected to the driven part and the slide assembly can be connected to the drive part.

The toothed member 12 includes a plate 16 which is preferably circular in plan. The plate 16 has a circumferential surface 18 with a plurality of teeth 20 having side surfaces 22 (FIG. 4). As seen, the tooth surfaces 22 define an arc. The teeth 20 are evenly and regularly spaced about the circumferential surface 18. A shaft 24 extends from the plate 16. The shaft 24 allows for the toothed member 12 to be connected to the drive or driven part. The shaft 24 can be connected to the drive or driven part in any conventional manner. Although the toothed member is shown as a plate with a shaft, the toothed member could also simply be a shaft having the teeth 20 formed around its circumferential surface at the end of the shaft.

The slide assembly 14 includes a ring 30 having a base 32 and a wall 34 extending up from the base. The ring 30 has a single continuous outer surface 36 which forms an outer surface for both the base 32 and the wall 34. The base 32 and wall 34 also have inner surfaces 38 and 40, respectively. As seen in FIG. 2, the wall 34 is narrower than the base 32, and hence, a shoulder 42 is formed at the juncture of the wall 34 and base 32. A series of pockets 44 are formed in the base 32, and extend axially from the top surface of the shoulder 42. A groove 46 is formed in the inner surface 40 of the wall 34 above each pocket 44. The groove 46 has a surface which is effectively a continuation of the surface of pocket. Hence, there is a smooth transition between the pockets 44 and their corresponding grooves 46. Additionally, the grooves 46 have a radial depth of about one-half the diameter of the pockets 44. Although, the radial depth of the grooves 46 depends on the positioning of the pocket relative to the wall 34. The pockets 44 and corresponding grooves 46 are spaced evenly about the ring. The pockets 44 are shown to be circular in plan, and the grooves 46 are shown to be semi-circular. A circumferential slit or groove 48 is formed in the inner surface 40 of the wall 34, near the top of the ring 30.

The slide assembly 14 also includes a slide member 50 and a spring 52 which is received in each pocket 44. A snap ring 54 is received in the circumferential groove 48. The spring (which is preferably a coil spring) is received in the bottom of the pocket 44, and the slide member 50 is positioned in the pocket 44 and groove 46 above the spring. Hence, the spring 52 biases the slide member 50 axially, away from the base, and against the snap ring 54. The pocket 44 has a depth, such that when the spring 52 is compressed, the slide member 50 is substantially fully received in the pocket. Additionally, the snap ring 54 is positioned on the wall 34 such that the effective length of the groove 46 is less than the length of the slide member 50. Hence, the spring 52 cannot push the slide member 50 out of the pocket 44, and at least a portion of the slide member 50 will be received in the pocket when the slide member 50 is pushed against the snap ring 54. The slide member 50 is illustratively shown to be a roller. However, the slide member 50 could be any desired polygonal shape.

As can be appreciated, the pockets 44 and grooves 46 are shaped complementarily to the slide members 50. Hence, if a differently shaped slide member is used, the shape of the pockets and grooves would most likely also change.

The slide assembly 14 is preferably operatively connected to the driven part; however, as noted above; it can alternatively operatively be connected to the drive part. As seen, the slide assembly 14 is annular or ring-shaped and includes a central opening. The drive or driven part can be force fit within this opening to be frictionally received within the ring base 32, or otherwise positionally fixed within the opening to operatively connect the drive or driven part to the slide assembly. Alternatively, the bottom of the slide assembly can be closed (i.e., so that there is no opening), and a shaft can extend from the bottom of the slide assembly to operatively connect the slide assembly 14 to the drive or driven part. The exterior surface 36 of the ring can be grooved or toothed to operatively connect the inner ring to the drive or driven part by gears, a chain, or a pulley. Of course, other mechanical means known to those skilled in the art can be employed to connect the slide assembly 14 to the drive or driven part.

The shape and width of the teeth 20 are designed such that the teeth can fit between any of two adjacent slide members, as seen in FIG. 4. Additionally, the distance between adjacent teeth 20 is greater than the diameter of the slide member 50. The number of teeth 20 on the plate 16 is chosen to be different from the number of slide members 50 in the slide assembly 14. When the two members (i.e., the toothed member 12 and the slide assembly 14) are pushed together for engagement, at least, but not all, of the slide members 50 will be received between the teeth 20 of the toothed member. The slide members 50 in the slide assembly 14 that do not fall between two adjacent teeth will be pushed into the slide member pockets 44 or seats. The interaction of the slide members 50 that are received in the gap between the teeth 20, and the teeth 20, will rotationally fix the toothed member and slide assembly together. Hence, rotational movement of the toothed member will be transferred to the slide assembly.

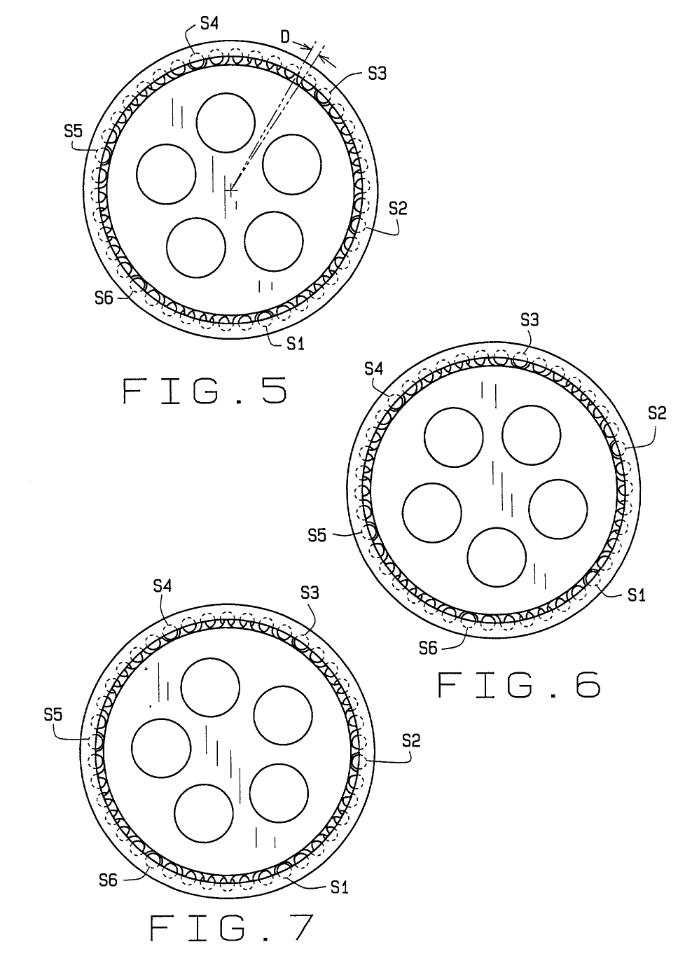

For any angular alignment of the two members 12 and 14, there will always be N number of slide members 50 that align between two adjacent teeth 20. These slide members will not be pushed into the slide assembly pockets, and instead, they will engage with the teeth 20 to transmit torque and/or power from the drive part to the driven part. FIGS. 5-7 depict different angular alignments about a common axis between the toothed member 12 and the slide assembly 14. In each Figure, there are always six (6) slide members S1-S6 that fall between adjacent teeth.

The number N of slide members that engage with the teeth is equal to the difference between the number of slide members (S) and the number of teeth (T). Hence, the number N of slide members that engage the teeth is given by the following equation:

N=S−T (1)

To ensure the engaging slide members evenly share the torque load, the umber of teeth (T) is chosen to be evenly divisible by N. Stated differently, the modulus of T/N=0. Hence, T=qN, where q is a positive integer (i.e., q≧1).

The maximum angular clearance D (in radians) (FIG. 5) between a slide member and a tooth is shown by the following equation:

$$D = \frac{2 π ( S - T )}{{T}^{2}} radians \qquad ( 2 )$$

The maximum angular clearance D represents the worst case scenario that an initial relative angular movement could occur before torque and/or power is transferred between the drive and driven parts. For most cases, the initial angular movement between two engaging members will be smaller than the value D given by the equation. As can be seen, from the equation (2), increasing the number of teeth (T) can effectively reduce the maximum possible clearance between a slide member and tooth, and thus increase the smoothness for torque and/or power transmission.

In the figures, the toothed member 12 has 36 teeth, and the slide member assembly has 42 slide members. Hence, per equation (1), there are 42-36 or 6 slide members S1-S6 that engage the teeth when the two members are engaged; and the maximum angular clearance D is:

$$D = \frac{2 π ( 42 - 36 )}{{36}^{2}} = 0.029 radian$$

In operation, the toothed member 12 and the slide assembly 14 are operatively connected to drive and driven parts, respectively. When the two members are not engaged, no power or torque is transmitted from the drive to the driven part. As the two members are brought together, N number of tooth gaps will align with N number of slide members. The remaining slide members will be pushed into their respective pockets 44 by the teeth 20, as the axial surface of the teeth engage the end surface of the slide members. When the two members 12 and 14 are engaged, the slide members 50 will be held in the gap between the teeth, rotationally fixing the two members together. Hence, the drive part and driven part will be operatively connected via the clutch 10, and the drive part can transfer torque and/or power to the driven part.

As noted above, the surfaces 22 of the teeth 20 are curved, or define an arc. As seen in the figures, the arc or curvature of the tooth surfaces 22 is slightly greater than the curvature of the slide member 50. However, the slide members need not be circular in cross-section. Rather, the slide members 50 can have generally any desired polygonal shape. The pockets 44 and grooves 46 of the slide assembly are preferably shaped to correspond to the shape of the slide members so that the slide members can smoothly slide axially in the pockets 44 and grooves 46. Additionally, the tooth surfaces 22 should correspond generally to the shape of the slide member (i.e., the tooth surfaces 22 should have the same basic shape as the slide members 50) to allow for a efficient engagement between the slide members 50 and the teeth 20.

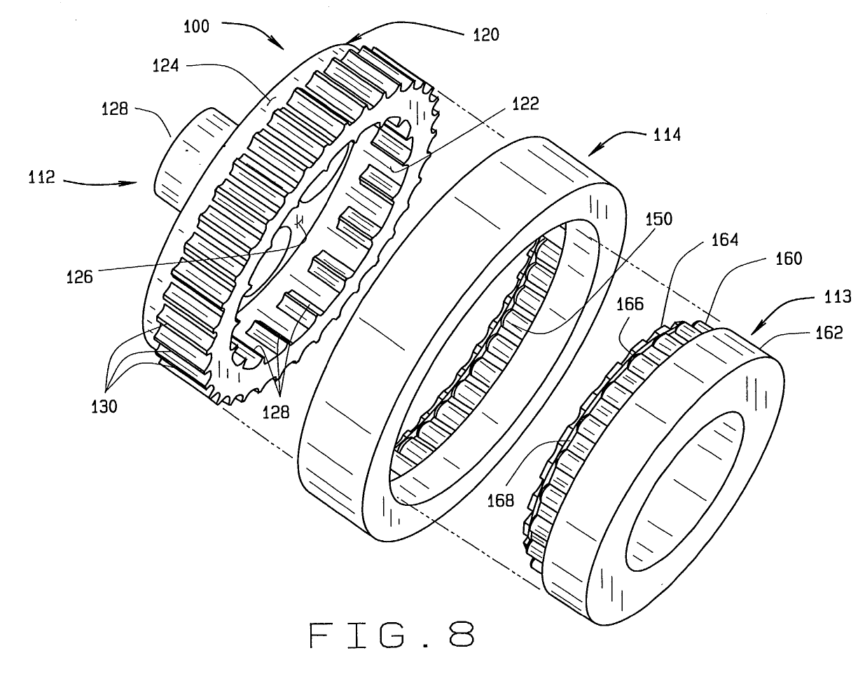

Another embodiment of the locking clutch is shown in FIG. 8. The locking clutch 100 is similar to the locking clutch 10, however, rather than having one toothed member and one slide assembly, the clutch 100 includes one toothed member 120 and two slide assemblies—an inner slide assembly 113 and an outer slide assembly 114.

The toothed member 112 has a ring 120 at its end having an inner surface 122 and an outer surface 124. A plate 126 covers one end of the ring 120, and a shaft 128 extends from the plate 126 to connect the member 112 to a drive part. A plurality of inner teeth 128 are formed on the inner surface; and a plurality of outer teeth 130 are formed on the outer surface 124. The teeth 128 and 130 are generally similar in shape to each other, and to the teeth 20 of the clutch 10, inasmuch as the teeth have side surfaces which, as shown, are arcuate. The teeth 128 and 130 are evenly and regularly spaced about their respective surfaces. The toothed member 112 could also be formed from a shaft having a cup formed at its end. This cup would then have a toothed outer surface and a toothed inner surface.

The outer slide assembly 114 is identical to the slide assembly 14 of the clutch 10, and is not described herein. When the outer slide assembly 114 is engaged with the toothed member 112, at least one of the slide members 150 of the outer slide assembly are received in at least one of the gaps between the outer teeth 130 of the toothed member. The engagement of the outer slide assembly with the outer teeth 130 of the toothed member is identical to the engagement of the slide members 50 of the slide assembly 14 with the teeth 20 of the toothed member 12, as described above.

The inner slide assembly 113 is generally similar in construction to the outer slide assembly 114. However, rather than having slide members in pockets on the interior of the slide assembly, the slide assembly 113 has slide members 160 received in pockets on the exterior surface of the slide assembly 113. The manner in which the exterior surface of the inner slide assembly is formed is substantially similar to the manner in which the interior surface of the outer slide assembly 114 (or the slide assembly 14) is formed. That is, the slide assembly 113 has a base 162 from which a wall 164 extends to define an outer shoulder. Pockets (not shown) are formed in the outer shoulder, which open into grooves 166 in the wall. Springs (not shown) and the slide members 160 are received in the pockets and held in place in the slide assembly 113 by a snap ring 168 which surrounds the wall 164.

When the inner slide assembly 113 is engaged with the toothed member 112, some of the slide members 160 of the inner slide assembly are received in the gaps between inner teeth 128 of the toothed member 112. The engagement of the inner slide assembly 113 with the inner teeth 128 of the toothed member is identical to the engagement of the slide members 50 of the slide assembly 14 with the teeth 20 of the toothed member 12, as described above.

The clutch 100 allows for one or both of the ring assemblies 113 and 114 to be engaged with the toothed member 112 at any one time. Hence, two driven parts can be driven by a single drive part. Thus, the clutch has four modes or operating positions: (1) neither slide assembly is engaged with the toothed member 112, preventing any transmission of torque and/or power from the drive part to either driven part; (2) only the inner slide assembly 113 is engaged with the toothed member 112 so that torque and/or power is transmitted only to a first of the driven parts; (3) only the outer slide assembly 114 is engaged with the toothed member 112 so that torque and/or power is transmitted only to a second of the driven parts; or (4) both ring assemblies are engaged with the toothed member 112, so that torque and/or power is transmitted to both of the driven parts.

As can be appreciated, the inner slide assembly 113 can be connected to a first driven member; and the outer slide assembly 114 can be connected to a second driven member. For example, the inner slide assembly 113 is shown to be annular and has a central opening. The first driven part can be force fit within this opening, or otherwise permanently fixed within the opening. Alternatively, the bottom of the inner slide assembly can be closed (i.e., so that there is no opening), and a shaft can extend from the bottom of the inner slide assembly to operatively connect the inner slide assembly 114 to the first driven part. Further, the exterior surface of the inner ring base 162 can be grooved or toothed to operatively connect the inner ring to the drive part by gears or by a pulley.

The outer slide assembly can similarly have a toothed or grooved outer surface to connect the outer slide assembly 114 to the second driven part by means of gearing, a chain, or a pulley. Other mechanical expedients known to those skilled in the art can also be used to connect the outer slide assembly 114 to the second drive part.

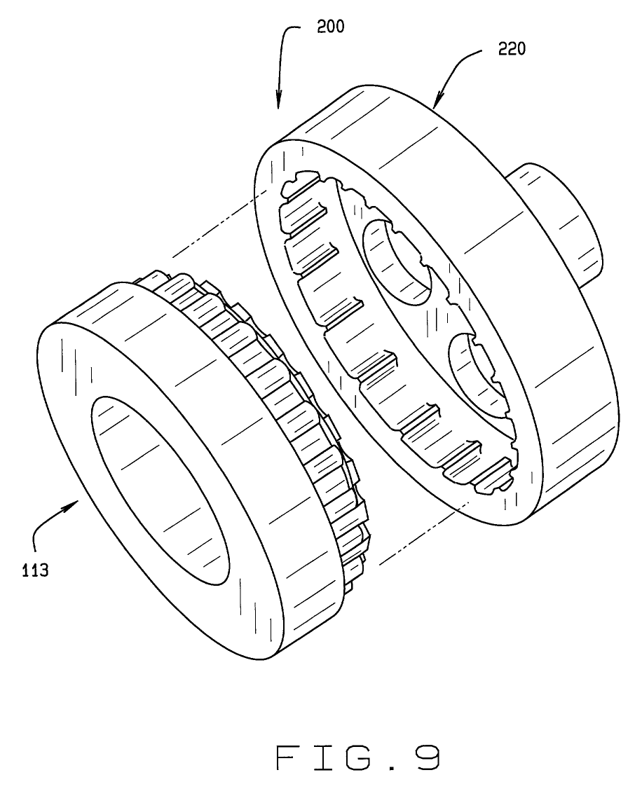

Another embodiment of the clutch is shown in FIG. 9. The clutch 200 of FIG. 9 includes the inner slide member 113 of FIG. 8. The toothed member 220 is substantially similar to the toothed member 120 of FIG. 8. However, the toothed member 220 has a smooth, rather than a toothed, outer surface. As can be appreciated, the clutch 200 is substantially the clutch 100, but without the outer slide member 114.

As various changes could be made in the above constructions without departing from the scope of the invention, it is intended that all matter contained in the above description or shown in the accompanying drawings shall be interpreted as illustrative and not in a limiting sense. Although a coiled spring is preferred to urge the slide members outwardly of their pockets, the coiled spring could be replaced with any compressible, resilient member. The snap rings 54 and 166 act as stops to prevent the slide members (or other tooth engaging members) from exiting their respective pockets. Other types of stops could be used as well. For example, a pin could extend radially through the slide members which is received in a closed groove in the pocket (i.e., the groove does not open into the slide assembly shoulder), or the slide member could be provided with a foot, and the pocket could have a shoulder near the top surface of the base which would engage the slide member foot. Both these modifications would require that the ring be formed as a two piece part—a main body with the pockets which are opened at the bottom to receive the slide member (or tooth engaging member) and a bottom cover to close the bottom of the body. The toothed member and the slide assemblies can be operatively connected to their respective drive and driven parts in any conventional manner. These examples are merely illustrative.

1. A locking clutch comprising:
a toothed member; the toothed member comprising a cylindrical surface and a plurality of teeth spaced about and extending from said cylindrical surface; and
a slide assembly; the slide assembly comprising a base and a wall extending from an end surface of said base; said base and wall defining a shoulder; a plurality of pockets formed in said shoulder; a slide member received in said pocket; and a spring member in said pocket which urges said slide member axially;
the teeth of said toothed member being spaced apart to define a gap between said teeth; said gap having a width, at radial ends of said teeth, at least as large as the width of said slide members, whereby, when said toothed member and said slide assembly are urged into engagement, at least one of said slide members is received in a tooth gap of said toothed member; and the remaining of said slide members are urged at least partially into their respective pockets.

2. The locking clutch of claim 1 wherein said slide assembly further includes a plurality of grooves formed in said wall above said pockets; there being a groove for each pocket.

3. The locking clutch of claim 1 wherein said teeth extend from an exterior surface of said tooth member; said slide assembly pockets being on an interior surface of said slide assembly wall.

4. The locking clutch of claim 1 wherein said toothed member is, at least partially, annular in shape, having an inner surface and an outer surface; said toothed surface being said inner surface; said slide assembly grooves being on an exterior surface of said slide assembly wall.

5. The locking clutch of claim 1 wherein the number of teeth is not equal to the number of slide members.

6. The locking clutch of claim 5 wherein the number of teeth is smaller than the number of slide members; and, wherein the number of teeth is evenly divisible by the difference between the number of slide members and the number of teeth.

7. The locking clutch of claim 1 wherein the teeth have side surfaces; said teeth side surfaces defining a shape corresponding to the external shape of said slide members.

8. The locking clutch of claim 7 wherein said slide members are rollers and said teeth side surfaces are arcuate.

9. The locking clutch of claim 1 wherein said slide assembly further comprises a stop to prevent said slide member from fully exiting said pocket.

10. The locking clutch of claim 9 wherein said stop comprises a ring extending around said wall; said ring being spaced from an upper surface of said base a distance less than the length of said slide members.

11. The locking clutch of claim 1 wherein said gap between said teeth, has a width, at the ends of said teeth, greater than the width of said slide members.

12. The locking clutch of claim 1 wherein said toothed member is, at least partially, in the shape of a ring and has both an inner surface and an outer surface; said teeth comprising outer teeth extending from said toothed member outer surface; said toothed member further including inner teeth extending radially inwardly from said toothed member inner surface;
said slide assembly comprising an outer slide assembly; said outer slide assembly having its said slide members formed on an inner surface of said wall of said outer slide assembly;
said clutch further comprising an inner slide assembly; said inner slide assembly comprising a base and a wall extending from an end surface of said base; said wall having an outer surface; said base and wall defining a shoulder at said wall outer surface; a plurality of pockets formed in said shoulder; a slide member received in said pocket; and a spring member in said pocket which urges said slide member axially.

13. The locking clutch of claim 12 wherein said inner slide assembly further includes a plurality of grooves formed in said wall outer surface above said pockets; there being a groove for each pocket

14. A locking clutch comprising:
a toothed member; the toothed member comprising an outer cylindrical surface and a plurality of teeth spaced about and extending from said outer cylindrical surface; and
a slide assembly; the slide assembly comprising a base and a wall extending from an end surface of said base; said base and wall each having an inner surface; said base inner surface being spaced radially inwardly from said wall inner surface; said base and wall defining a shoulder at a junction of said wall inner surface with an end surface of said base; a plurality of pockets formed in said shoulder; a slide member received in each said pocket; and a resilient member in each said pocket which urges said slide member axially; and a stop to prevent said slide members from fully exiting said pockets;
said slide assembly having more slide members than does the toothed member have teeth; the teeth of said toothed member being spaced apart to define a gap between said teeth; said gap having a width, at radial ends of said teeth, at least as large as the width of said slide members; whereby, when said toothed member and said slide assembly are urged into engagement, at least some of said slide members are received in said gaps; and the remaining of said slide members are urged into said pockets.

15. A clutch comprising:
a toothed member comprising an cylindrical inner surface and a cylindrical outer surface; a plurality of outer teeth spaced about and extending from said outer surface; and a plurality of inner teeth spaced about and extending from said inner surface;
an outer slide assembly; the outer slide assembly comprising a base and a wall extending from an end surface of said base; said base and wall each having an inner surface; said base inner surface being spaced radially inwardly from said wall inner surface; said base and wall defining a shoulder at a junction of said wall inner surface with an end surface of said base; a plurality of pockets formed in said shoulder; a slide member in each pocket, and a spring member in each said pocket which urges said slide member axially; and a stop to prevent said slide members from fully exiting said pockets; and
an inner slide assembly; the inner slide assembly comprising a base and a wall extending from an end surface of said base; said base and wall each having an outer surface; said base outer surface being spaced radially outwardly from said wall outer surface; said base and wall defining a shoulder at a junction of said wall outer surface with an end surface of said base; a plurality of pockets formed in said shoulder; a slide member received in each said pocket; and a spring member in each said pocket which urges said slide member axially; and a stop to prevent said slide members from fully exiting said pockets;
the inner and outer teeth of said respective toothed members being spaced apart to define gaps between said inner teeth and gaps between said outer teeth; said gaps between said inner teeth and said gaps between said outer teeth having widths, at radial ends of said respective teeth, at least as large as the width of said slide members, whereby, when said toothed member and said inner slide assembly are urged into engagement, at least one of said inner slide assembly slide members is received in an inner tooth gap of said toothed member; and the remaining of said inner slide assembly slide members are urged into their respective pockets; and, when said toothed member and said outer slide assembly are urged into engagement, at least one of said outer slide assembly slide members is received in an outer tooth gap of said toothed member; and the remaining of said outer slide assembly slide members are urged into their respective pockets.
